(19) United States
(12) Patent Application Publication
(10) Pub. No.: US 2014/0126109 A1
(43) Pub. Date: May 8, 2014

(54) MULTILAYER CERAMIC ELECTRONIC COMPONENT AND FABRICATING METHOD THEREOF

(71) Applicant: SAMSUNG ELECTRO-MECHANICS CO., LTD., Suwon (KR)

(72) Inventors: Young Ho KIM, Suwon (KR); Ro Woon LEE, Suwon (KR); Hyoung Wook LIM, Suwon (KR)

(73) Assignee: SAMSUNG ELECTRO-MECHANICS CO., LTD., Suwon (KR)

(21) Appl. No.: 13/746,997

(22) Filed: Jan. 22, 2013

(30) Foreign Application Priority Data
Nov. 5, 2012 (KR) 10-2012-0124300

(51) Int. Cl. H01G 4/008; C04B 35/468; H01G 13/00

(52) U.S. Cl. CPC H01G 4/0085; H01G 13/00; C04B 35/468
USPC 361/305; 264/618

(57) ABSTRACT

There is provided a multilayered ceramic electronic component including: a ceramic body including dielectric layers; internal electrodes disposed to face each other, having the dielectric layers therebetween; and external electrodes formed on outer surfaces of the ceramic body and electrically connected to the internal electrodes, wherein the internal electrodes include a first ceramic powder formed of barium titanate (BaTiO₃) and having a particle diameter corresponding to 70% to 100% of a thickness of the respective internal electrodes. According to the present invention, disconnection generated due to differences in contraction and extension between the internal electrodes and the dielectric layers may be improved, whereby the multilayered ceramic electronic component having excellent capacitance and reliability may be implemented.

### CROSS-REFERENCE TO RELATED APPLICATIONS

This application claims the priority of Korean Patent Application No. 10-2012-0124300 filed on Nov. 5, 2012, in the Korean Intellectual Property Office, the disclosure of which is incorporated herein by reference.

### BACKGROUND OF THE INVENTION

1. Field of the Invention

The present invention relates to a high capacitance multilayer ceramic electronic component having excellent reliability and a fabricating method thereof.

2. Description of the Related Art

In accordance with the recent trend for the miniaturization of electronic products, demand for a multilayer ceramic electronic component having a reduced size and high capacitance has increased.

Therefore, dielectric layers and internal electrodes have been thinned and stacked in increasing amounts through various methods. Recently, as the thickness of dielectric layers has been reduced, multilayer ceramic electronic components having increased numbers of stacked layers have been fabricated.

A general fabricating method of a multilayer ceramic capacitor includes preparing a slurry, by mixing a ceramic powder, a binder, a solvent and printing a conductive paste to form an internal electrode, and separating a ceramic sheet from a film to form a multilayer green ceramic body. A green chip is fabricated by compressing the multilayer green ceramic body at high temperature and high pressure to form a hard green multilayer body (Bar) and then performing a cutting process thereon. Then, the ceramic multilayer capacitor is completed by performing a plasticizing process, a firing process, a polishing process, an external electrode coating process, and a plating process thereon.

Here, stress between an internal electrode and a dielectric layer generated by a difference between contraction and extension causes disconnection. A disconnected part is present in a second phase form due to a reaction between an additive and nickel, and the second phase form has a negative influence on capacitance and breakdown voltage (BDV).

Therefore, nickel is controlled to be contracted by using a second ceramic powder (BaTiO₃) having a particle diameter of 50 nm or less and a first ceramic powder (BaTiO₃) having a particle diameter of 300 nm or more, similar to a thickness of the internal electrode is applied to naturally form disconnection, such that it is required to deteriorate the stress generated by a difference in a firing temperature between the dielectric layer and the internal electrode, and a disconnected portion is filled with the dielectric layer having electrical characteristics to decrease bad effects such as capacitance and breakdown voltage (BDV) to thereby improve the reliability.

### RELATED ART DOCUMENT

(Patent Document 1) Korean Patent Laid-Open Publication No. KR 2006-0079897
(Patent Document 2) Korean Patent Laid-Open Publication No. KR 2012-0032567

### SUMMARY OF THE INVENTION

An aspect of the present invention provides a high capacitance multilayer ceramic electronic component having excellent reliability by applying a first ceramic powder (BaTiO₃) having a particle diameter corresponding to an internal electrode thickness to an internal electrode in order to improve disconnections generated due to differences in contraction and extension between the internal electrode and an dielectric layer.

According to an aspect of the present invention, there is provided a multilayer ceramic electronic component including: a ceramic body including dielectric layers; internal electrodes disposed to face each other, having the dielectric layers therebetween; and external electrodes formed on outer surfaces of the ceramic body and electrically connected to the internal electrodes, wherein the internal electrodes may include a first ceramic powder formed of barium titanate (BaTiO₃) and having a particle diameter corresponding to 70% to 100% of a thickness of the respective internal electrodes.

The first ceramic powder may have a particle diameter of 300 nm to 400 nm.

The first ceramic powder may be included in an amount of 2 wt % to 10 wt % of the internal electrodes.

The internal electrode may include a second ceramic powder formed of barium titanate (BaTiO₃) and having a particle diameter corresponding to 1% to 20% of the respective internal electrodes.

The second ceramic powder may have a particle diameter of 10 nm to 50 nm.

The first ceramic powder may be included in an amount of 2.5 wt % to 12.5 wt %, based on 100 wt % of the second ceramic powder.

The dielectric layers may be stacked in an amount of 100 layers to 1000 layers.

The ceramic body may include barium titanate (BaTiO₃).

According to another aspect of the present invention, there is provided a fabricating method of a multilayer ceramic electronic component, the fabricating method including: preparing ceramic green sheets including dielectric layers; forming internal electrode patterns on the ceramic green sheets by using a conductive paste for an internal electrode including a conductive metal powder and a ceramic powder; stacking and sintering the ceramic green sheets having the internal electrode patterns formed thereon to form a ceramic body including internal electrodes therein, the internal electrodes being disposed so as to face each other; and forming external electrodes on upper and lower surfaces and end surfaces of the ceramic body, wherein in the forming of the conductive paste for an internal electrode, the conductive paste may include a first ceramic powder having a particle diameter corresponding to 70% to 100% of a thickness of the internal electrode.

The first ceramic powder may have a particle diameter of 300 nm to 400 nm.

The first ceramic powder may be included in an amount of 2 wt % to 10 wt % of the internal electrode.

The internal electrode may include a second ceramic powder formed of barium titanate (BaTiO₃) and having a particle diameter corresponding to 1% to 20% of a thickness of the internal electrode.

The second ceramic powder may have a particle diameter of 10 nm to 50 nm.

The first ceramic powder may be included in an amount of 2.5 wt % to 12.5 wt % based on 100 wt % of the second ceramic powder.

The conductive metal powder may be at least one of silver (Ag), lead (Pb), platinum (Pt), nickel (Ni), and copper (Cu).

The dielectric layers may be stacked in an amount of 100 layers to 1000 layers.

The ceramic body may include barium titanate (BaTiO₃).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line B-B′ of FIG. 1;

FIG. 3 is a view showing an example in which a first ceramic powder is included between internal electrodes;

FIG. 4 is a scanning electron microscope (SEM) photograph showing a state in which the internal electrodes according to the embodiment of the present invention are filled with the first ceramic powder; and

FIG. 5 is a view showing a fabricating process of a multilayer ceramic capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

A multilayer ceramic electronic component according to an embodiment of the present invention may be appropriately used in a multilayer ceramic capacitor, a multilayer varistor, a thermistor, a piezoelectric element, a multilayer substrate, or the like, having a structure in which a dielectric layer corresponding to a ceramic layer is used and internal electrodes face each other, having the dielectric layer therebetween.

Embodiments of the present invention will now be described in detail with reference to the accompanying drawings.

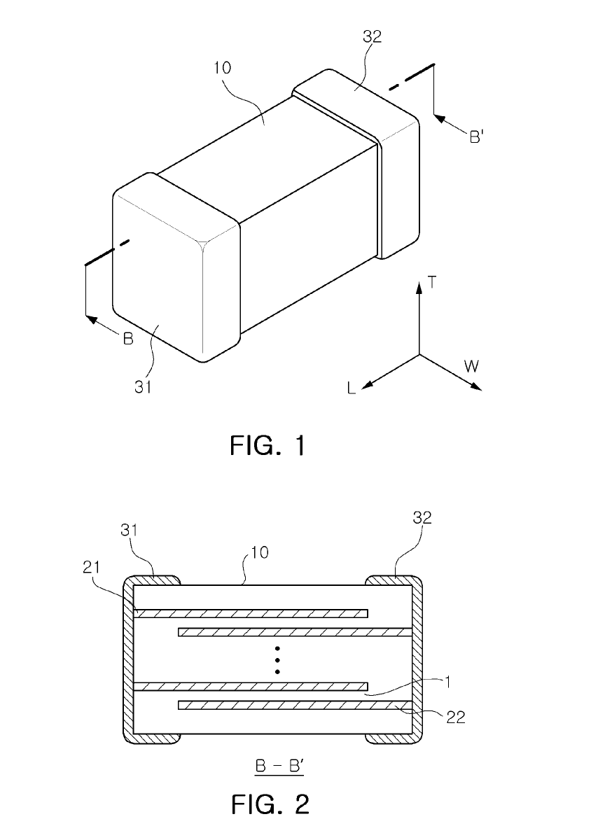

FIG. 1 is a perspective view schematically showing a multilayer ceramic capacitor according to an embodiment of the present invention.

FIG. 2 is a cross-sectional view taken along line B-B′ of FIG. 1.

Referring to FIGS. 1 and 2, the multilayer ceramic electronic component according to the embodiment of the present invention may include: a ceramic body 10 including dielectric layers 1; a plurality of internal electrodes 21 and 22 disposed to face each other, having the dielectric layers 1 therebetween in the ceramic body 10; and external electrodes 31 and 32 electrically connected to the plurality of internal electrodes 21 and 22.

Hereinafter, the multilayer ceramic electronic component according to the embodiment of the present invention will be described. In particular, a multilayer ceramic capacitor will be described as the multilayer ceramic electronic component. However, the present invention is not limited thereto.

In the multilayer ceramic capacitor according to the embodiment of the present invention, a ‘length direction’ refers to an ‘L’ direction, a ‘width direction’ refers to a ‘W’ direction, and a ‘thickness direction’ refers to a ‘T’ direction of FIG. 1. Here, the ‘thickness direction’ is the same as a direction in which dielectric layers are stacked, that is, a ‘lamination direction’.

According to the embodiment of the present invention, a raw material forming the dielectric layers 1 is not particularly limited as long as sufficient capacitance may be obtained therewith, but may be a barium titanate (BaTiO₃) powder.

In a material forming the dielectric layers 1, various ceramic additives, organic solvents, plasticizers, binders, dispersing agents, and the like, may be added to a powder such as a barium titanate (BaTiO₃) powder, or the like, according to an object of the present invention.

An average particle diameter of a ceramic powder used in forming of the dielectric layers 1 is not particularly limited, but may be controlled in order to achieve an object of the present invention. For example, the average particle diameter of the ceramic powder may be controlled to be 400 nm or less.

Respective one ends of the internal electrodes 21 and 22 may be alternately exposed to end surfaces of the ceramic body 10 in the length direction.

A material forming the internal electrodes 21 and 22 is not particularly limited, but may be a conductive paste formed of at least one material of silver (Ag), lead (Pb), platinum (Pt), nickel (Ni), and copper (Cu), for example.

In addition, the internal electrodes 21 and 22 may include nickel (Ni), and a ceramic material for forming the ceramic body is not particularly limited, but may be barium titanate (BaTiO₃).

In order to form capacitance, the external electrodes 31 and 32 may be formed on outer surfaces of the ceramic body 10, and electrically connected to the internal electrodes 21 and 22.

The external electrodes 31 and 32 may be formed of the same conductive material as the internal electrodes, but are not limited thereto. For example, the external electrodes 31 and 32 may be formed of copper (Cu), silver (Ag), nickel (Ni), or the like.

In addition, the external electrodes 31 and 32 are not particularly limited, but may include a conductive metal having 60 wt % or less based on a total weight thereof.

The external electrodes 31 and 32 may be formed by applying a conductive paste to the outer surfaces of the ceramic body, the conductive paste being prepared by adding glass frits to the metal powder, and performing firing thereon.

As the dielectric layers 1 and the internal electrodes 21 and 22 are simultaneously fired, the temperature at which a material configuring the dielectric layers 1 is sintered is different from the temperature at which a material configuring the internal electrodes 21 and 22 is sintered, such that a difference in shrinkage rate between the two materials is generated, whereby the possibility that cracks are generated may be high in the multilayer ceramic electronic component.

Therefore, in the case in which the internal electrodes 21 and 22 include a second ceramic powder having a particle diameter of 10 nm to 50 nm therein, the contraction of nickel is controlled to delay the contraction thereof. In the case in which the internal electrodes 21 and 22 include a first ceramic powder 11 having a particle diameter of 300 nm to 4000 nm, disconnection generated due to differences in contraction and extension between the internal electrodes 21 and 22 and the dielectric layers 1 may be prevented.

The second ceramic powder and the first ceramic powder 11 may be formed of barium titanate (BaTiO₃), the same material as that of the dielectric layers 1. The reason is that the disconnection generated due to the differences in contraction and extension between the internal electrodes 21 and 22 and the dielectric layers 1, is improved. Therefore, the same material as that of the dielectric layers 1 may be used in the internal electrodes 21 and 22.

The second ceramic powder and the first ceramic powder 11 may be included in amounts corresponding to 2 wt % to 10 wt % based on the total weight of the internal electrodes 21 and 22. Here, in the case in which the amounts of the second ceramic powder and the first ceramic powder 11 are 2 wt % or less, they are not sufficient to prevent the disconnection of the internal electrodes 21 and 22, and in the case in which the amounts of the second ceramic powder and the first ceramic powder 11 are wt % or more, they are excessive for preventing the disconnection of the internal electrodes 21 and 22, which is not preferable.

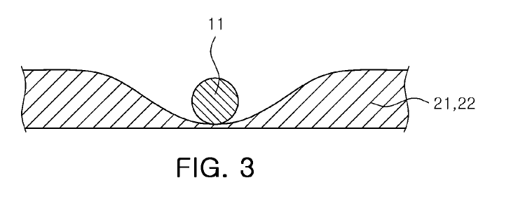

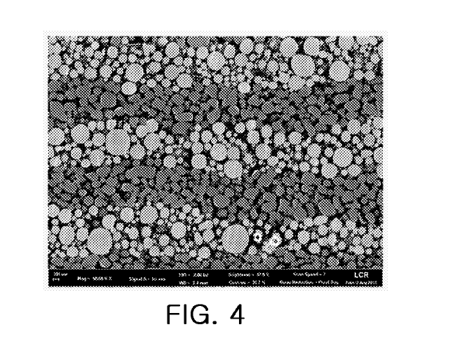

FIG. 3 is a view showing an example in which the first ceramic powder 11 is included between internal electrodes 21 and 22.

Referring to FIG. 3, the first ceramic powder 11 may be formed between the internal electrodes 21 and 22 and generally have a particle diameter corresponding to 70% to 100% of a thickness of the respective internal electrodes 21 and 22.

FIG. 4 is a scanning electron microscope (SEM) photograph showing a state in which the internal electrodes 21 and 22 according to the embodiment of the present invention are filled with the first ceramic powder 11 having a particle diameter corresponding to the thickness of the respective internal electrodes 21 and 22.

Hereafter, although the present invention will be described in detail with reference to Comparative Example and Inventive Example, it is not limited thereto.

### INVENTIVE EXAMPLE (1)

According to the present embodiment, internal electrodes having thicknesses of 0.35 μm and 0.4 μm were prepared. Here, a nickel powder having a particle diameter of 180 nm, a second ceramic powder having a particle diameter of 20 nm, and a first ceramic powder having a particle diameter of 300 nm were prepared in configuring the internal electrodes. Experiments were performed by changing an amount of the first ceramic powder to 1.25%, 2.5%, 12.5%, and 37.5%, respectively, based on 100wt % of the second ceramic powder. Results thereof are shown in Table 1 below.

TABLE 1

| | | | | Ratio (%) of | | | |
|---|---|---|---|---|---|---|---|
| | | Particulate | Coarse | Second | | | |
| Internal | | Common | Common | Ceramic | | | |
| Electrode | Nickel | Material | Material | Powder:First | | | |
| Thickness | Powder | Powder | Powder | Ceramic | | Electrode | Breakdown |
| (μm) | (nm) | (nm) | (nm) | Powder | Capacitance | Connectivity | Voltage |
| 0.35 | 180 | 20 | 300 | 1.25 | ◯ | ◯ | ◯ |
| | 180 | 20 | 300 | 2.5 | ⊚ | ⊚ | ⊚ |
| | 180 | 20 | 300 | 12.5 | ⊚ | ⊚ | ⊚ |
| | 180 | 20 | 300 | 25 | ◯ | ◯ | ⊚ |
| | 180 | 20 | 300 | 37.5 | ◯ | ◯ | ◯ |
| 0.4 | 180 | 20 | 300 | 1.25 | ◯ | ◯ | ◯ |
| | 180 | 20 | 300 | 2.5 | ⊚ | ⊚ | ⊚ |
| | 180 | 20 | 300 | 12.5 | ⊚ | ⊚ | ⊚ |
| | 180 | 20 | 300 | 25 | ◯ | ◯ | ⊚ |
| | 180 | 20 | 300 | 37.5 | ◯ | ◯ | ◯ |

1) Capacitance: X (Defective, 90% or less), ◯ (Good, 90~95%), ⊚ (Excellent, 95% or more)
2) Electrode connectivity: X (Defective, 80% or less), ◯ (Good, 80~85%), ⊚ (Excellent, 85% or more)
3) Brakdown voltage: X (Defective, 50 V or less), ◯ (Good, 50~75 V), ⊚ (Excellent, 75 V or more)

As shown in Table 1 above, the case in which the ratio of the first ceramic powder based on 100 wt % of the second ceramic powder is 1.25% to 37.5% showed superior capacitance, electrode connectivity, and breakdown voltage.

In particular, the case in which the ratio of the first ceramic powder based on 100 wt % of the second ceramic powder is 2.5% to 12.5% showed significantly excellent capacitance, electrode connectivity, and breakdown voltage. In this case, a disconnected portion of the internal electrodes 21 and 22 was filled with the first ceramic powder having a particle diameter similar to the thickness of the respective internal electrodes 21 and 22 by using the first ceramic powder having a particle diameter approximating to the thickness of the respective internal electrodes 21 and 22 and having the same composition as that of the dielectric layers 1 while the contraction of the nickel powder is controlled by the second ceramic powder, whereby the stress generated by a difference in firing temperature between the dielectric layers 1 and the internal electrodes 21 and 22 may be deteriorated, and the disconnection of the internal electrodes 21 and 22 may be prevented.

Therefore, it can be appreciated that the ratio of the first ceramic powder based on 100wt % of the second ceramic powder needs to be 2.5% to 12.5% in order to fabricate a high capacitance multilayer ceramic electronic component having excellent reliability.

### COMPARATIVE EXAMPLE (1)

According to the present embodiment, internal electrodes having thicknesses of 0.35 μm and 0.4 μm were prepared. Here, a nickel powder having a particle diameter of 180 nm, a second ceramic powder having a particle diameter of 20 nm, and a first ceramic powder having a particle diameter of 300 nm were prepared in configuring the internal electrodes. Experiments were performed by changing a ratio of the first ceramic powder to 0%, 0.25%, 50%, 75%, and 100% based on 100wt % of the second ceramic powder. Results thereof are shown in Table 2 below.

TABLE 2

| | | | | Ratio (%) of | | | |
|---|---|---|---|---|---|---|---|
| | | Particulate | | Second | | | |
| Internal | | Common | Coarse Common | Ceramic | | | |
| Electrode | Nickel | Material | Material | Powder:First | | | |
| Thickness | Powder | Powder | Powder | Ceramic | | Electrode | Breakdown |
| (μm) | (nm) | (nm) | (nm) | Powder | Capacitance | Connectivity | Voltage |
| 0.35 | 180 | 20 | 300 | 0 | X | ◯ | ◯ |
| | 180 | 20 | 300 | 0.25 | X | ◯ | ◯ |
| | 180 | 20 | 300 | 50 | ◯ | X | ◯ |
| | 180 | 20 | 300 | 75 | X | X | ◯ |
| | 180 | 20 | 300 | 100 | X | X | ◯ |
| 0.4 | 180 | 20 | 300 | 0 | X | ◯ | ◯ |
| | 180 | 20 | 300 | 0.25 | X | ◯ | ◯ |
| | 180 | 20 | 300 | 50 | ◯ | X | ◯ |
| | 180 | 20 | 300 | 70 | X | X | ◯ |
| | 180 | 20 | 300 | 100 | X | X | ◯ |

1) Capacitance: X (Defective, 90% or less), ◯ (Good, 90~95%), ⊚ (Excellent, 95% or more)
2) Electrode connectivity: X (Defective, 80% or less), ◯ (Good, 80~85%), ⊚ (Excellent, 85% or more)
3) Breakdown voltage: X (Defective, 50 V or less), ◯ (Good, 50~75 V), ⊚ (Excellent, 75 V or more)

As shown in Table 2 above, the case in which the ratio of the first ceramic powder based on 100 wt % of the second ceramic powder was 0% to 0.25% or 50% to 100% showed defective capacitance, electrode connectivity, and breakdown voltage.

In particular, there was no case in which the BDV was defective due to the ratio included in the first ceramic powder based on 100 wt % of the second ceramic powder; but either of capacitance and electrode connectivity was defective in the case in which the ratio of the first ceramic powder based on 100wt % of the second ceramic powder is 0% to 0.25% or 50% to 100%.

Therefore, it could be appreciated that it is difficult to fabricate the high capacitance multilayer ceramic electronic component having excellent reliability in the case in which the ratio of the first ceramic powder based on 100 wt % of the second ceramic powder is 0% to 0.25% or 50% to 100%.

In the multilayer ceramic electronic component according to another embodiment of the present invention, descriptions of elements overlapped with the description of the multilayer ceramic electronic component according to one embodiment of the present invention will be omitted.

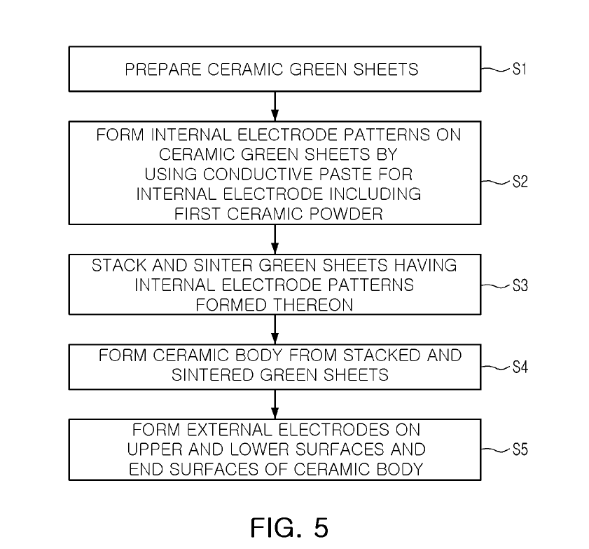

FIG. 5 is a view showing a fabricating process of a multilayer ceramic capacitor according to another embodiment of the present invention.

Referring to FIG. 5, the fabricating method of the multilayer ceramic electronic component is provided, the fabricating method including: preparing ceramic green sheets including dielectric layers S1; forming internal electrode patterns on the ceramic green sheets by using a conductive paste for an internal electrode including a conductive metal powder and a ceramic powder S2; stacking and sintering the green sheets having the internal electrode patterns formed thereon S3 to form a ceramic body including internal electrodes therein, the internal electrodes being disposed so as to face each other S4; and forming external electrodes on upper and lower surfaces of the ceramic body and end surfaces thereof S5, wherein in the forming of the conductive paste for an internal electrode, the conductive paste includes the first ceramic powder having a particle diameter corresponding to 70% to 100% of a thickness of the internal electrode.

In the fabricating method of the multilayer ceramic electronic component according to the embodiment of the present invention, a slurry containing a powder such as a barium titanate (BaTiO₃) powder, or the like, may be applied to carrier films and dried thereon to prepare a plurality of ceramic green sheets, thereby forming the dielectric layers.

The ceramic green sheets may be produced by preparing a slurry mixed together with a ceramic powder, a binder, and a solvent, and then forming the slurry as sheets each having a thickness of several μm by using a doctor blade method.

The conductive metal powder may be at least one of silver (Ag), lead (Pb), platinum (Pt), nickel (Ni), and copper (Cu).

In addition, the ceramic body may include barium titanate (BaTiO₃).

Parts the same as the characteristics of the multilayer ceramic electronic component according to the embodiment of the present invention will be omitted.

As set forth above, according to the present invention, disconnection generated due to differences in contraction and extension between the internal electrodes and the dielectric layers can be improved, whereby the multilayer ceramic electronic component having excellent capacitance and reliability may be implemented.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component comprising:
a ceramic body including dielectric layers;
internal electrodes disposed to face each other, having the dielectric layers therebetween; and
external electrodes formed on outer surfaces of the ceramic body and electrically connected to the internal electrodes,
wherein the internal electrodes include a first ceramic powder formed of barium titanate (BaTiO₃) and having a particle diameter corresponding to 70% to 100% of a thickness of the respective internal electrodes.

2. The multilayer ceramic electronic component of claim 1, wherein the first ceramic powder has a particle diameter of 300 nm to 400 nm.

3. The multilayer ceramic electronic component of claim 1, wherein the first ceramic powder is included in an amount of 2 wt % to 10 wt % of the internal electrodes.

4. The multilayer ceramic electronic component of claim 1, wherein the internal electrodes include a second ceramic powder formed of barium titanate (BaTiO₃) and having a particle diameter corresponding to 1% to 20% of the respective internal electrodes.

5. The multilayer ceramic electronic component of claim 4, wherein the second ceramic powder has a particle diameter of 10 nm to 50 nm.

6. The multilayer ceramic electronic component of claim 4, wherein the first ceramic powder is included in an amount of 2.5 wt % to 12.5 wt % based on 100 wt % of the second ceramic powder.

7. The multilayer ceramic electronic component of claim 1, wherein the dielectric layers are stacked in an amount of 100 layers to 1000 layers.

8. The multilayer ceramic electronic component of claim 1, wherein the ceramic body includes barium titanate (BaTiO₃).

9. A fabricating method of a multilayer ceramic electronic component, the fabricating method comprising:
preparing ceramic green sheets including dielectric layers;
forming internal electrode patterns on the ceramic green sheets by using a conductive paste for an internal electrode including a conductive metal powder and a ceramic powder;
stacking and sintering the ceramic green sheets having the internal electrode patterns formed thereon to form a ceramic body including internal electrodes therein, the internal electrodes being disposed so as to face each other; and
forming external electrodes on upper and lower surfaces and end surfaces of the ceramic body,
wherein in the forming of the conductive paste for an internal electrode, the conductive paste includes a first ceramic powder having a particle diameter corresponding to 70% to 100% of a thickness of the internal electrode.

10. The fabricating method of claim 9, wherein the first ceramic powder has a particle diameter of 300 nm to 400 nm.

11. The fabricating method of claim 9, wherein the first ceramic powder is included in an amount of 2 wt % to 10 wt % of the internal electrode.

12. The fabricating method of claim 9, wherein the internal electrode includes a second ceramic powder formed of barium titanate (BaTiO₃) and having a particle diameter corresponding to 1% to 20% of a thickness of the internal electrode.

13. The fabricating method of claim 12, wherein the second ceramic powder has a particle diameter of 10 nm to 50 nm.

14. The fabricating method of claim 12, wherein the first ceramic powder is included in an amount of 2.5 wt % to 12.5 wt % based on 100 wt % of the second ceramic powder.

15. The fabricating method of claim 9, wherein the conductive metal powder is at least one of silver (Ag), lead (Pb), platinum (Pt), nickel (Ni), and copper (Cu).

16. The fabricating method of claim 9, wherein the dielectric layers are stacked in an amount of 100 layers to 1000 layers.

17. The fabricating method of claim 9, wherein the ceramic body includes barium titanate (BaTiO₃).
